(19) United States
(12) Patent Application Publication
(10) Pub. No.: US 2008/0236757 A1
(43) Pub. Date: Oct. 2, 2008

(54) SHEET LAMINATING APPARATUS

(75) Inventors: Kuo-Jung Huang, Taipei (TW); Fa Chou, Dongguan (CN)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 11/934,521

(22) Filed: Nov. 2, 2007

(30) Foreign Application Priority Data
Mar. 30, 2007 (TW) 096111156

(51) Int. Cl. B32B 41/00

(52) U.S. Cl. 156/367

(57) ABSTRACT

The present invention relates to a sheet laminating apparatus for laminating plural sheet articles. The transmitting speed of the sheet laminating apparatus is determined according to the thickness of the sheet articles. By adjusting the transmitting speed, the possibility of getting jammed is minimized. A laminating time upper limit is determined according to the thickness of said sheet articles according to the transmitting speed. The laminating time upper limit is used as an index of discriminating whether a jam event occurs.

### FIELD OF THE INVENTION

The present invention relates to a sheet laminating apparatus, and more particularly to a sheet laminating apparatus for laminating a sheet article between two pieces of thermoplastic films.

### BACKGROUND OF THE INVENTION

Conventionally, a sheet article such as a document or a photo is usually covered with a protective film for protection because such a sheet article is readily suffered from damage. Typically, a sheet laminating apparatus is used for laminating a sheet article between two pieces of protective films. There are several types of sheet laminating apparatuses. For illustration, a conventional sheet laminating apparatus is illustrated as follows.

Referring to FIG. 1, a schematic cross-sectional view of a conventional sheet laminating apparatus is illustrated. The sheet laminating apparatus 10 of FIG. 1 principally comprises a heat-treating mechanism 20, a transmitting and pressing mechanism 30 and a transfer passage 40. The heat-treating mechanism 20 includes an electrically-heated plate 21 and heater 22.

The process for laminating a sheet article (not shown) by using the sheet laminating apparatus 10 will be described as follows. First of all, the sheet article is sandwiched between an upper thermoplastic film and a lower thermoplastic film to form a sandwich structure. Then, the sandwich structure is fed into the transfer passage 40 of the sheet laminating apparatus 10 through an entrance 41. By means of the transmitting and pressing mechanism 30, the sandwich structure is continuously transported through the passage 40. During this stage, the electrically-heated plate 21 of the heat-treating mechanism 20 transforms electricity to heat energy so as to preheat the sandwich structure. The heat energy generated by the electrically-heated plate 21 is uniformly distributed over the heater 22, and radiated through an air gap between the heater 22 and the transmitting and pressing mechanism 30 so as to heat up the transmitting and pressing mechanism 30. The transmitting and pressing mechanism 30 presses against opposite sides of the sandwich structure which is transported through the transfer passage 40, and transmits the heat energy to the sandwich structure so as to soften the thermoplastic films. Being transmitted and pressed by the transmitting and pressing mechanism 30, the sheet article bonds with the softened thermoplastic films to form a laminate structure. Meanwhile, the sheet article is fixed between these two pieces of thermoplastic films.

For most conventional sheet laminating apparatuses utilizing heat energy to laminate sheet articles, the problem of getting jammed is commonly found. In a case that the sheet article is adhered to the transmitting and pressing mechanism 30 during the process of transmitting and pressing the sandwich structure, or in another case that the thermoplastic films become too soft due to the elevated temperature, the possibility of getting jam in the transfer passage 40 is largely increased. If the sheet article is jammed in the transfer passage 40, the user may generally pull out the jammed sheet article by exerting a pulling force on the sheet article. If the problem of getting jammed is very serious, however, the pulling force is usually insufficient to pull out the jammed sheet article. Under this circumstance, the sheet laminating apparatus may have a breakdown.

Therefore, there is a need of providing an improved sheet laminating apparatus to effectively prevent the sheet article from getting jammed.

### SUMMARY OF THE INVENTION

It is an object of the present invention to provide a sheet laminating apparatus having an enhanced laminating effect.

Another object of the present invention provides a sheet laminating apparatus by using a laminating time upper limit as an index of discriminating whether a jam event occurs, thereby eliminating the jam event in advance.

In accordance with an aspect of the present invention, there is provided a sheet laminating apparatus for laminating plural sheet articles. The sheet laminating apparatus includes a transfer passage, a heat-treating mechanism, a transmitting and pressing mechanism, a first sensor, a second sensor and a control unit. The transfer passage includes an entrance and an exit. The sheet articles are fed into the transfer passage. The heat-treating mechanism is disposed beside the transfer passage for heating the sheet articles when the sheet articles are transported across the transfer passage. The transmitting and pressing mechanism is disposed beside the transfer passage for transmitting the sheet articles through the transfer passage at a transmitting speed and pressing the sheet articles. The transmitting and pressing mechanism is operated in a positive transmitting direction to transmit the sheet articles toward the exit, and the transmitting and pressing mechanism is operated in a reverse transmitting direction to transmit the sheet articles toward the entrance. The first sensor is disposed at the entrance of the transfer passage for detecting the thickness of the sheet articles entering the transfer passage. The second sensor is disposed at the exit of the transfer passage for discriminating whether the sheet articles reach the exit. The control unit is electrically connected to the transmitting and pressing mechanism, the first sensor and the second sensor for controlling the transmitting speed and the transmitting direction of the transmitting and pressing mechanism. The control unit records the thickness of the sheet articles and an initial time spot of the sheet article beginning to enter the transfer passage. A laminating time upper limit and the transmitting speed are determined according to the thickness of the sheet articles. The control unit controls transmission of the transmitting and pressing mechanism in the reverse transmitting direction to transmit the sheet articles.

In an embodiment, the transmitting speed is reduced as the thickness of the sheet articles is increased, and the transmitting speed is increased as the thickness of the sheet articles is reduced.

In an embodiment, the heat-treating mechanism includes a heater.

In an embodiment, the heat-treating mechanism includes a preheating plate and a heater.

In an embodiment, the transmitting and pressing mechanism includes a roller assembly.

In an embodiment, the transmitting and pressing mechanism includes a transmission belt.

Preferably, the first sensor and the second sensor are piezoelectric crystals.

Preferably, the first sensor and the second sensor are photoelectric interrupt switches.

Preferably, the first sensor and the second sensor are micro switches.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view of a conventional sheet laminating apparatus;

FIG. 2 is a schematic block diagram of a sheet laminating apparatus according to a broad concept of the present invention;

FIGS. 3(a) and 3(b) are schematic cross-sectional views showing a sheet laminating apparatus according to a first preferred embodiment of the present invention;

FIG. 4 is a schematic cross-sectional view showing a sheet laminating apparatus according to a second preferred embodiment of the present invention; and

FIG. 5 is a schematic cross-sectional view showing a sheet laminating apparatus according to a third preferred embodiment of the present invention.

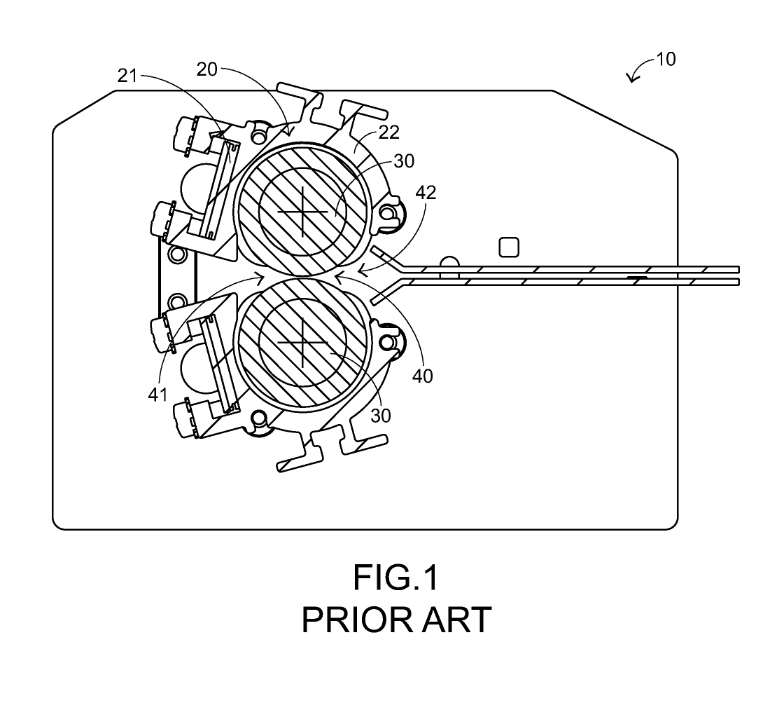

### DETAILED DESCRIPTION OF THE PREFERRED EMBODIMENT

For overcoming the above described drawbacks resulting from the prior art, the present invention provides an improved sheet laminating apparatus to effectively prevent the sheet article from getting jammed, thereby avoiding breakdown of the sheet laminating apparatus.

As known, it is critical to control the temperature required for laminating the sheet article. Generally, as the temperature is increased, the possibility of getting jammed is increased. On the contrary, if the temperature is very low, the insufficient heat energy fails to implement desired laminating effect. Typically, the heat energy provided by the heat-treating mechanism is substantially constant within a specified time period. Consequently, the amount of heat energy adsorbed by the sandwich structure is dependent on the time required for performing the transmitting and pressing operation. The time required for performing the transmitting and pressing operation is determined according to the transmitting speed of the transmitting and pressing mechanism. As the transmitting speed is increased, the heat energy adsorbed by the thermoplastic films is reduced. On the contrary, as the transmitting speed is decreased, the heat energy adsorbed by the thermoplastic films is increased. Furthermore, it is found that the amount of heat energy adsorbed by the thermoplastic films correlates with the thickness of the sheet article. As the thickness of the sheet article is increased, the amount of heat energy adsorbed by the thermoplastic films is increased; as the thickness of the sheet article is decreased, the amount of heat energy adsorbed by the thermoplastic films is reduced.

In accordance with a specific feature of the present invention, the transmitting speed of the transmitting and pressing mechanism is determined according to the thickness of the sheet article, and the time required for performing the transmitting and pressing operation is determined according to the transmitting speed. The time required for performing the transmitting and pressing operation is an index of discriminating whether a jam event occurs and the jamming degree. According to the jamming degree, different measures should be taken as required.

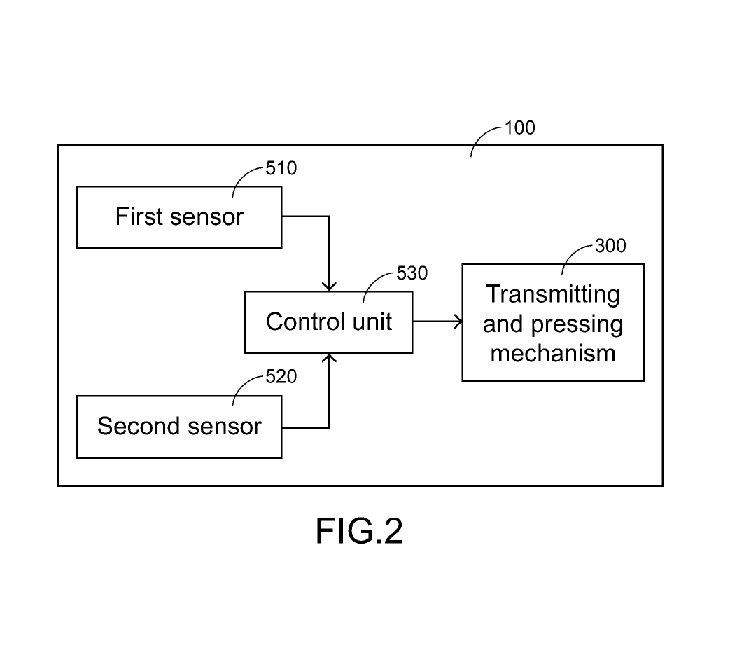

Referring to FIG. 2, a schematic block diagram of a sheet laminating apparatus according to a broad concept of the present invention is illustrated. The sheet laminating apparatus 100 of FIG. 2 includes a first sensor 510, a second sensor 520, a control unit 530 and a transmitting and pressing mechanism 300. The first sensor 510 and the second sensor 520 are disposed at the entrance and the exit of the sheet laminating apparatus 100, respectively. When a combination of sheet article, an upper thermoplastic film and a lower thermoplastic film is fed into the transfer passage of the sheet laminating apparatus 100 through an entrance, the first sensor 510 disposed at the entrance detects the thickness of the sheet article. Meanwhile, the data associated with the thickness of the sheet article and an initial time spot are sent to the control unit 530. By the control unit 530, these data are recorded, and a transmitting speed of the transmitting and pressing mechanism 300 and a laminating time upper limit are determined according to the thickness of the sheet article. As the thickness of the sheet article is reduced, the transmitting speed is increased and the laminating time upper limit is shortened; as the thickness of the sheet article is increased, the transmitting speed is reduced and the laminating time upper limit is extended. When the sheet article reaches the exit of the sheet laminating apparatus 100, the second sensor 520 detects the presence of the sheet article. In a case that the sheet article is detected by the second sensor 520 within the laminating time upper limit which is counted from the initial time spot, a sensing signal is transmitted to the control unit 530. In response to the sensing signal issued from the second sensor 520, the control unit 530 controls the transmitting and pressing mechanism 300 to implement the transmitting and pressing operation in a positive transmitting direction. Whereas, in a case that the sheet article has not been detected by the second sensor 520 within the laminating time upper limit, it is meant that a jam event occurs. Under this circumstance, the control unit 530 controls the transmitting and pressing mechanism 300 to rotate in a reverse transmitting direction, thereby ejecting the sheet article backwardly to the entrance of the sheet laminating apparatus 100.

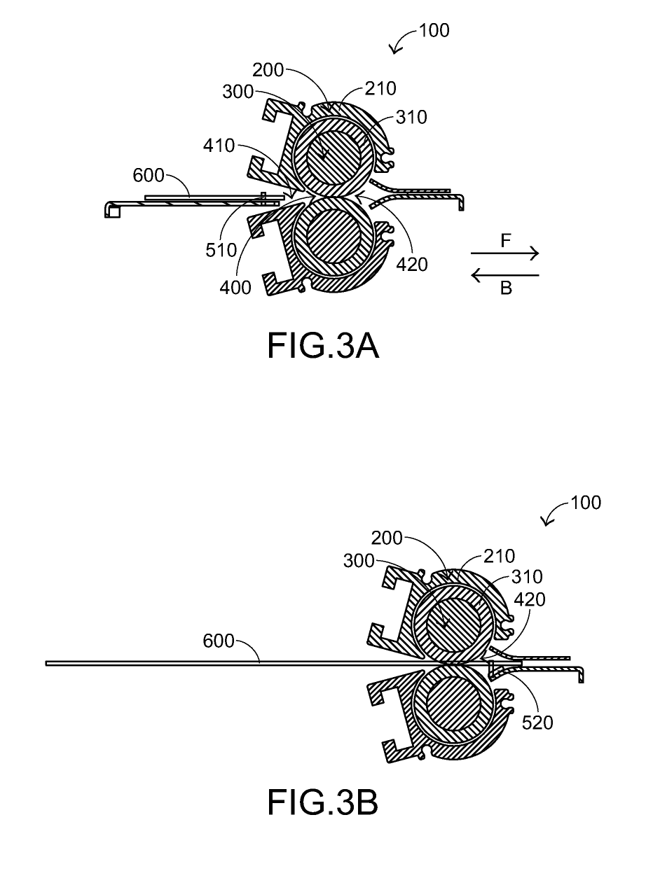

FIGS. 3(a) and 3(b) are schematic cross-sectional views showing a sheet laminating apparatus according to a first preferred embodiment of the present invention. The sheet laminating apparatus 100 principally comprises a heat-treating mechanism 200, a transmitting and pressing mechanism 300, a transfer passage 400, a first sensor 510, a second sensor 520 and a control unit (not shown in this drawing). The heat-treating mechanism 200 includes a heater 210. The transmitting and pressing mechanism 300 includes a roller assembly 310, which includes a pair of rollers. Examples of the first sensor 510 and the second sensor 520 include but are not limited to piezoelectric crystals, photoelectric interrupt switches or micro switches. The control unit 530 is a circuit board having a control circuit (not shown) mounted thereon.

The transfer passage 400 includes an entrance 410 and an exit 420. The heater 210 and the roller assembly 310 are disposed beside the transfer passage 400. The roller assembly 310 is enclosed by the heater 210. The first sensor 510 and the second sensor 520 are disposed at the entrance 410 and the exit 420 of the transfer passage 400, respectively. The roller assembly 310, the first sensor 510 and the second sensor 520 are electrically connected to the control unit 530.

Hereinafter, a process of laminating a sheet article (not shown) by using the sheet laminating apparatus 100 will be described with reference to FIGS. 3(a) and 3(b).

First of all, as shown in FIG. 3(a), a sheet article 600 is sandwiched between an upper thermoplastic film and a lower thermoplastic film to form a sandwich structure. Then, the sandwich structure is fed into the transfer passage 400 of the sheet laminating apparatus 100 through the entrance 410. Once the first sensor 510 disposed at the entrance 410 detects the thickness of the sheet article 600, the data associated with the thickness of the sheet article 600 is sent to the control unit 530. An initial time spot when the sheet article 600 begins to enter the entrance 410 of the transfer passage 400 which is also recorded by the control unit 530. According to the thickness of the sheet article 600, the control unit 530 figures out a transmitting speed of the transmitting and pressing mechanism 300 and a laminating time upper limit required for implementing the transmitting and pressing operation.

Next, as shown in FIG. 3(b), the sandwich structure is continuously transported across the transfer passage 400 in a positive transmitting direction F. During this stage, the heater 210 of the heat-treating mechanism 200 transforms electricity to heat energy so as to preheat the sandwich structure. The heat energy generated by the heater 210 is radiated through an air gap between the heater 210 and the roller assembly 310 so as to heat up the roller assembly 310. The roller assembly 310 presses against opposite sides of the sandwich structure which is transported through the transfer passage 40, and transmit the heat energy to the sandwich structure so as to soften the thermoplastic films. In a case that the sheet article has not been detected by the second sensor 520 at the exit 420 of the transfer passage 400 after the laminating time upper limit from the initial time spot has elapsed, it is meant that a jam event occurs. Under this circumstance, the control unit 530 controls the roller assembly 310 to rotate in a reverse transmitting direction B by changing from the positive transmitting direction F, thereby ejecting the sheet article backwardly to the entrance 410 of the transfer passage 400. When the jam event just occurs, the front segment of the sandwich structure has been adhered onto the roller assembly 310 but the middle segment of the sandwich structure has not yet been adhered onto the roller assembly 310. As a consequence, rotating the roller assembly 310 in the reverse transmitting direction B may separate the front segment of the sandwich structure from the roller assembly 310 without difficulty. Since the sheet article 600 is withdrawn from the sheet laminating apparatus 100, the possibility of breakdown resulting from paper jam is minimized. On the contrary, if the sheet article has been detected by the second sensor 520 at the exit 420 of the transfer passage 400 within the laminating time upper limit, the sandwich structure continuously advances in the positive transmitting direction F so as to implement the transmitting and pressing operation.

More specially, depending on the thickness of the sheet article, the transmitting and pressing mechanism 300 is operated at different transmitting speeds to implement the transmitting and pressing operation. Since the laminating time upper limit is correlated to the transmitting speed, the flexibility of using the sheet laminating apparatus is expanded.

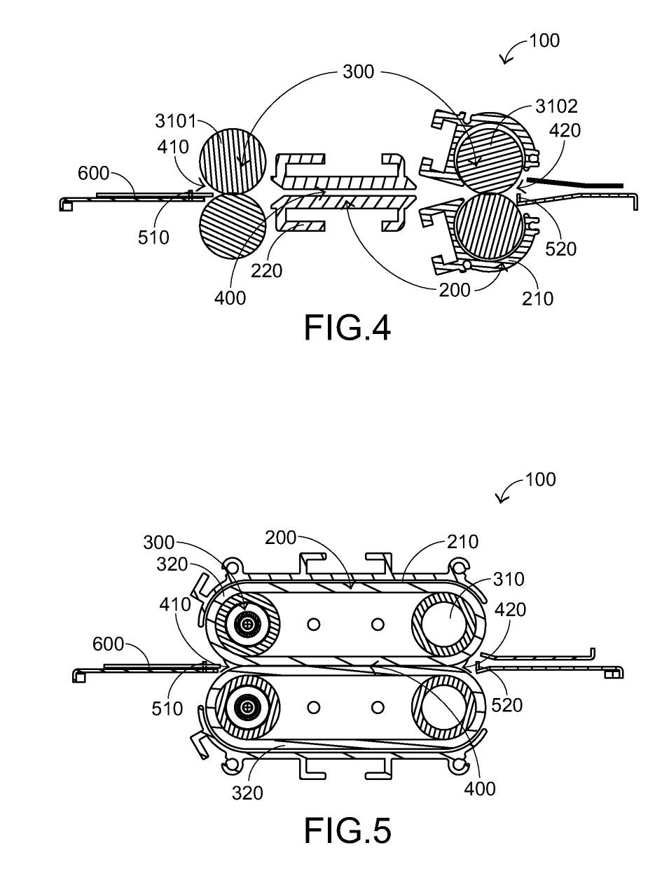

FIG. 4 is a schematic cross-sectional view showing a sheet laminating apparatus according to a second preferred embodiment of the present invention. The heat-treating mechanism 200 includes a heater 210 and a preheating plate 220, which are disposed beside the transfer passage 400. The transmitting and pressing mechanism 300 includes a first roller assembly 3101 and a second roller assembly 3102. The first roller assembly 3101 and the second roller assembly 3102 are disposed in the vicinity of the entrance 410 and the exit 420 of the transfer passage 400, respectively. In comparison with the first embodiment of FIG. 3, the sheet laminating apparatus 100 of FIG. 4 is fed into the transfer passage 400 by the first roller assembly 3101. When the sandwich structure advances in the transfer passage 400, the preheating plate 220 beside the transfer passage 400 heats up the transfer passage 400 so as to preheat the sandwich structure. The sandwich structure is then transmitted and pressed by the second roller assembly 3102 so as to form a laminate structure. The other operations are identical to those described in FIG. 3, and are not redundantly described herein.

FIG. 5 is a schematic cross-sectional view showing a sheet laminating apparatus according to a third preferred embodiment of the present invention. The transmitting and pressing mechanism 300 includes two roller assemblies 310 and two transmission belts 320. The heat-treating mechanism 200 includes a heater 210 whose layout configuration is shown in FIG. 5. The transfer passage 400 is defined between these two transmission belts 320. In this embodiment, the sandwich structure is transmitted and pressed by the transmission belts 320. Due to the simultaneous heating and pressing operation performed by the transmission belts 320, the laminating effect is enhanced and thus the problem of forming bubbles is significantly eliminated.

It is noted that, however, those skilled in the art will readily observe that numerous modifications and alterations may be made while retaining the teachings of the invention. By using the sheet laminating apparatus of the present invention, the laminating effect is enhanced and the possibility of breakdown resulting from paper jam is minimized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A sheet laminating apparatus for laminating plural sheet articles, said sheet laminating apparatus comprising:
a transfer passage including an entrance and an exit, said sheet articles being fed into said transfer passage;
a heat-treating mechanism disposed beside said transfer passage for heating said sheet articles when said sheet articles are transported across said transfer passage;
a transmitting and pressing mechanism disposed beside said transfer passage for transmitting said sheet articles through said transfer passage at a transmitting speed and pressing said sheet articles, wherein said transmitting and pressing mechanism is operated in a positive transmitting direction to transmit said sheet articles toward said exit, and said transmitting and pressing mechanism is operated in a reverse transmitting direction to transmit said sheet articles toward said entrance;
a first sensor disposed at said entrance of said transfer passage for detecting the thickness of said sheet articles entering said transfer passage;
a second sensor disposed at said exit of said transfer passage for discriminating whether said sheet articles reach said exit; and
a control unit electrically connected to said transmitting and pressing mechanism, said first sensor and said second sensor for controlling said transmitting speed and said transmitting direction of said transmitting and pressing mechanism, said control unit recording the thickness of said sheet articles and an initial time spot of said sheet article beginning to enter said transfer passage, wherein a laminating time upper limit and said transmitting speed are determined according to the thickness of said sheet articles, and said control unit controls transmission of said transmitting and pressing mechanism in said reverse transmitting direction to transmit said sheet articles.

2. The sheet laminating apparatus according to claim 1 wherein said transmitting speed is reduced as the thickness of the sheet articles is increased, and said transmitting speed is increased as the thickness of the sheet articles is reduced.

3. The sheet laminating apparatus according to claim 1 wherein said heat-treating mechanism includes a heater.

4. The sheet laminating apparatus according to claim 1 wherein said heat-treating mechanism includes a preheating plate and a heater.

5. The sheet laminating apparatus according to claim 1 wherein said transmitting and pressing mechanism includes a roller assembly.

6. The sheet laminating apparatus according to claim 1 wherein said transmitting and pressing mechanism includes a transmission belt.

7. The sheet laminating apparatus according to claim 1 wherein said first sensor and said second sensor are piezoelectric crystals.

8. The sheet laminating apparatus according to claim 1 wherein said first sensor and said second sensor are photoelectric interrupt switches.

9. The sheet laminating apparatus according to claim 1 wherein said first sensor and said second sensor are micro switches.
